(19) United States
(12) Patent Application Publication
(10) Pub. No.: US 2002/0083471 A1
(43) Pub. Date: Jun. 27, 2002

(54) System and method for providing a multimedia summary of a video program

(75) Inventors: Lalitha Agnihotri, Fishkill, NY (US); Nevenka Dimitrova, Yorktown Heights, NY (US)

Correspondence Address: Michael E. Marion, c/o U.S. PHILIPS CORPORATION, Intellectual Property Department, 580 White Plains Road, Tarrytown, NY, 10591, US

(73) Assignee: PHILIPS ELECTRONICS NORTH AMERICA CORPORATION

(21) Appl. No.: 09/747,107

(22) Filed: Dec. 21, 2000

(51) Int. Cl. H04N 7/084; G06F 3/00; H04N 5/445; H04N 7/087; H04N 7/08; H04N 7/16

(52) U.S. Cl. 725/137; 348/473; 725/40

(57) ABSTRACT

For use in a video display system capable of displaying a video program, there is disclosed a system and method for creating a multimedia summary of the video program using transcript data and audio-video segments of the video program. The system comprises a multimedia summary generator that is capable of obtaining a transcript of the text of the video program and audio-video segments of the video program. The multimedia summary generator identifies topic cues and subtopic cues in the transcript of the video program. The multimedia summary generator also identifies audio-video segments that are associated with the topic cues and subtopic cues. The multimedia summary generator creates the multimedia summary by assembling the topic cues and the subtopic cues and their associated audio-video segments. Entry points are provided in the multimedia summary for each topic and subtopic so that a viewer of the multimedia summary can directly access each topic and subtopic.

### CROSS-REFERENCE TO RELATED APPLICATIONS

The present invention is related to the inventions disclosed in U.S. patent application Ser. No. [Docket No. PHA 701137] filed [Filing Date], entitled “METHOD AND APPARATUS FOR THE SUMMARIZATION AND INDEXING OF VIDEO PROGRAMS USING TRANSCRIPT INFORMATION” and in U.S. patent application Ser. No. 09/351,086 filed Jul. 9, 1999, entitled “METHOD AND APPARATUS FOR LINKING A VIDEO SEGMENT TO ANOTHER SEGMENT OR INFORMATION SOURCE” and in U.S. patent application Ser. No. [Docket No. PHA 701071] filed [Filing Date], entitled “SYSTEM AND METHOD FOR ORDERING ONLINE UTILIZING A DIGITAL TELEVISION RECEIVER” and in U.S. patent application Ser. No. [Docket No. PHA 701182EXT] filed [Filing Date], entitled “SYSTEM AND METHOD FOR ACCESSING A MULTIMEDIA SUMMARY OF A VIDEO PROGRAM.” These patent applications are commonly assigned to the assignee of the present invention. The disclosures of these related patent application are hereby incorporated herein by reference for all purposes as if fully set forth herein.

### TECHNICAL FIELD OF THE INVENTION

The present invention is directed to a system and a method for summarizing video programs, and more specifically, to a system and method for providing a multimedia summary of a video program using transcript information and video segments.

### BACKGROUND OF THE INVENTION

In the early days of television, there were few television broadcast channels available for viewing. As television technology advanced to include ultra-high frequency (UHF) channels, very high frequency (VHF) channels, cable television, satellite television reception, and Internet-based technology, the number of available television channels increased significantly.

The number of television programs available for viewing has also increased significantly. In terms of high definition television content, this amounts to over two hundred gigabytes (200 GB) of information per channel per day. It is becoming increasingly important for viewers to have the ability to quickly browse through the content description of video programs to enable a viewer to find a program or program segment that the viewer is interested in viewing. A major problem is that much of the content description of video programs is not readily accessible.

The current options for viewers who desire to view a recorded video program include 1) watching the entire video program, 2) fast forwarding through the recording of the entire video program in order to find the portion of the program that is of interest, and 3) using data from an Electronic Program Guide (EPG) that provides only a general program description.

There is presently no available system or method by which a viewer may easily identify the content of a video program. In particular, there is no available system or method by which a viewer can obtain a sufficiently detailed summary of the content of a video program.

There is therefore a need in the art for an improved system and method for providing a summary of a video program. There is a need in the art for an improved system and method for providing a multimedia summary of a video program using transcript information and video segments of the video program. There is also a need in the art for an improved system and method for providing a multimedia summary of a video program that may be accessed by a viewer at the start of any topic or subtopic in the video program.

### SUMMARY OF THE INVENTION

To address the above-discussed deficiencies of the prior art, it is a primary object of the present invention to provide, for use in a video display system capable of displaying a video program, a system and method for providing a multimedia summary of a video program.

The present invention comprises a multimedia summary generator that is capable of creating a multimedia summary of a video program. The multimedia summary generator is capable of obtaining a transcript of the text of the video program and video segments of the video program. The multimedia summary generator identifies topic cues and subtopic cues in the transcript of the video program. The multimedia summary generator also identifies video segments that are associated with the topic cues and subtopic cues. The multimedia summary generator creates the multimedia summary by assembling the topic cues and the subtopic cues and their associated video segments. Entry points are provided in the multimedia summary for each topic and subtopic so that a viewer of the multimedia summary can directly access each topic and subtopic.

According to an advantageous embodiment of the present invention, the multimedia summary generator is capable of combining portions of a transcript of a video program and portions of video segments of a video program to create a multimedia summary of the video program.

According to an advantageous embodiment of the present invention, the multimedia summary generator is capable of selecting a video segment that relates to a topic in the transcript of a video program and adding the topic and the video segment to the multimedia summary.

According to another advantageous embodiment of the present invention, the multimedia summary generator is capable of selecting a video segment that relates to a subtopic of a topic in the transcript of a video program and adding the subtopic and the video segment to the multimedia summary.

According to yet another embodiment of the present invention, the multimedia summary generator is capable of creating entry points in the multimedia summary to allow a viewer to access each topic and subtopic in the multimedia summary.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

Before undertaking the DETAILED DESCRIPTION, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. In particular, a controller may comprise one or more data processors, and associated input/output devices and memory, that execute one or more application programs and/or an operating system program. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 illustrates an exemplary video display system;

FIG. 2 illustrates an advantageous embodiment of a system for creating a viewer interactive multimedia summary of a video program that is implemented in the exemplary video display system shown in FIG. 1;

FIG. 3 illustrates computer software that may be used with an advantageous embodiment of the viewer interactive multimedia summary of the present invention;

FIG. 4 is a flow diagram illustrating the operation of an advantageous embodiment of the viewer interactive multimedia summary of the present invention in an exemplary video display system; and

FIG. 5 illustrates an exemplary display page of an advantageous embodiment of the viewer interactive multimedia summary of the present invention.

### DETAILED DESCRIPTION OF THE INVENTION

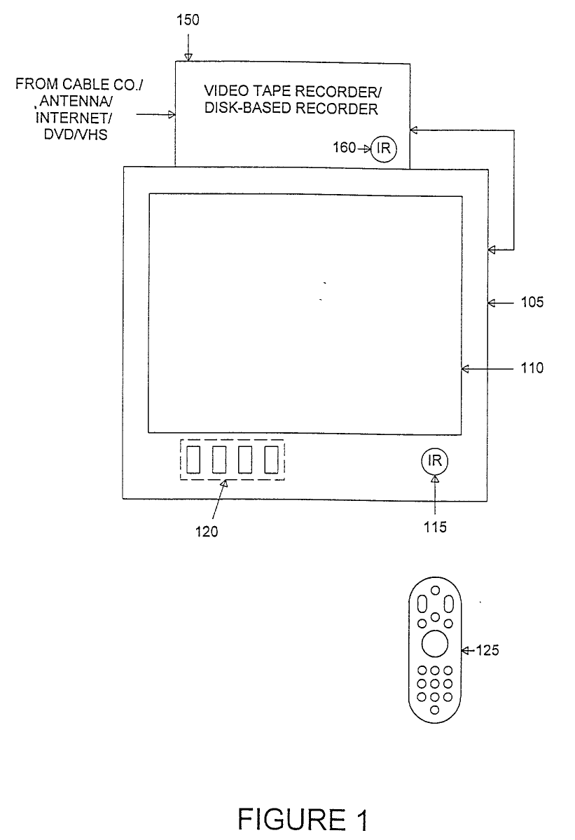

FIGS. 1 through 5, discussed below, and the various embodiments used to describe the principles of the present invention in this patent document are by way of illustration only and should not be construed in any way to limit the scope of the invention. In the description of the exemplary embodiment that follows, the present invention is integrated into, or is used in connection with, a television receiver. However, this embodiment is by way of example only and should not be construed to limit the scope of the present invention to television receivers. In fact, those skilled in the art will recognize that the exemplary embodiment of the present invention may easily be modified for use in any type of video display system.

FIG. 1 illustrates exemplary video recorder 150 and television set 105 according to one embodiment of the present invention. Video recorder 150 receives incoming television signals from an external source, such as a cable television service provider (Cable Co.), a local antenna, a satellite, the Internet, or a digital versatile disk (DVD) or a Video Home System (VHS) tape player. Video recorder 150 transmits television signals from a selected channel to television set 105. A channel may be selected manually by the viewer or may be selected automatically by a recording device previously programmed by the viewer. Alternatively, a channel and a video program may be selected automatically by a recording device based upon information from a program profile in the viewer's personal viewing history.

In Record mode, video recorder 150 may demodulate an incoming radio frequency (RF) television signal to produce a baseband video signal that is recorded and stored on a storage medium within or connected to video recorder 150. In Play mode, video recorder 150 reads a stored baseband video signal (i.e., a program) selected by the viewer from the storage medium and transmits it to television set 105. Video recorder 150 may also comprise a video recorder of the type that is capable of receiving, recording, interacting with, and playing digital signals.

Video recorder 150 may comprise a video recorder of the type that utilizes recording tape, or that utilizes a hard disk, or that utilizes solid state memory, or that utilizes any other type of recording apparatus. If video recorder 150 is a video cassette recorder (VCR), video recorder 150 stores and retrieves the incoming television signals to and from a magnetic cassette tape. If video recorder 150 is a disk drive-based device, such as a ReplayTV™ recorder or a TiVO™ recorder, video recorder 150 stores and retrieves the incoming television signals to and from a computer magnetic hard disk rather than a magnetic cassette tape. In still other embodiments, video recorder 150 may store and retrieve from a local read/write (R/W) digital versatile disk (DVD) or a read/write (R/W) compact disk (CD-RW). The local storage medium may be fixed (e.g., hard disk drive) or may be removable (e.g., DVD, CD-RW).

Video recorder 150 comprises infrared (IR) sensor 160 that receives commands (such as Channel Up, Channel Down, Volume Up, Volume Down, Record, Play, Fast Forward (FF), Reverse, and the like) from remote control device 125 operated by the viewer. Television set 105 is a conventional television comprising screen 110, infrared (IR) sensor 115, and one or more manual controls 120 (indicated by a dotted line). IR sensor 115 also receives commands (such as Volume Up, Volume Down, Power On, Power Off) from remote control device 125 operated by the viewer.

It should be noted that video recorder 150 is not limited to receiving a particular type of incoming television signal from a particular type of source. As noted above, the external source may be a cable service provider, a conventional RF broadcast antenna, a satellite dish, an Internet connection, or another local storage device, such as a DVD player or a VHS tape player. The incoming signal may be a digital signal, an analog signal, Internet protocol (IP) packets, or signals in other types of format.

For the purposes of simplicity and clarity in explaining the principles of the present invention, the descriptions that follow shall generally be directed to an embodiment in which video recorder 150 receives (from a cable service provider) incoming analog television signals that contain closed caption text information. Nonetheless, those skilled in the art will understand that the principles of the present invention may readily be adapted for use with digital television signals, wireless broadcast television signals, local storage systems, an incoming stream of IP packets containing MPEG data, and the like.

In addition, those skilled in the art will understand that the principles of the present invention may readily be adapted for use with other sources of text, including, but not limited to, text from a speech to text converter, text from a third party source, text from extracted video text, text from embedded screen text, and the like. Therefore, the term “transcript” shall be defined to mean a text file originating from any source of text, including, but not limited to, closed caption text, text from a speech to text converter, text from a third party source, text from extracted video text, text from embedded screen text, and the like.

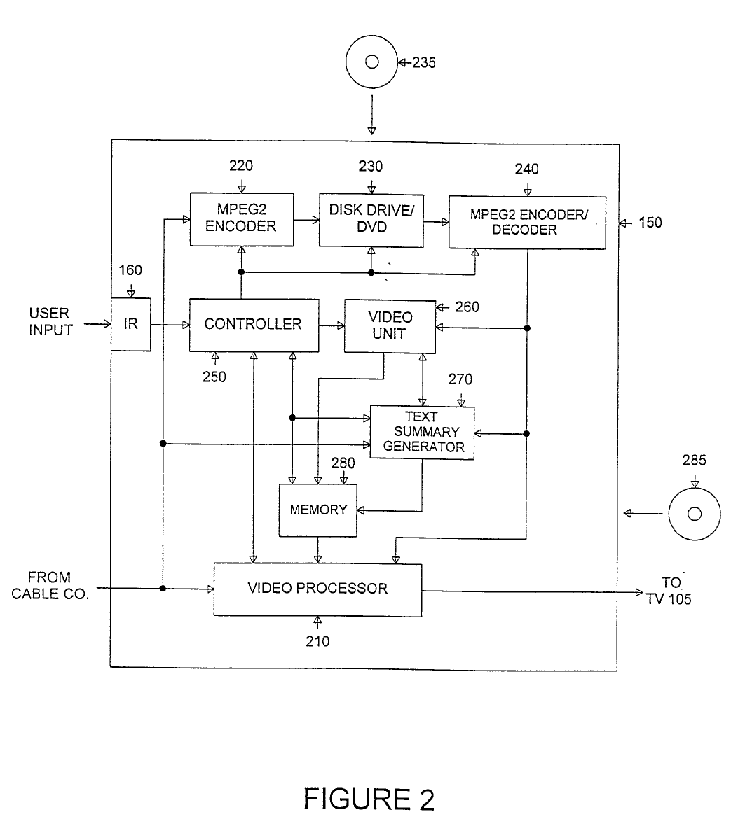

FIG. 2 illustrates exemplary video recorder 150 in greater detail according to one embodiment of the present invention. Video recorder 150 comprises IR sensor 160, video processor 210, MPEG2 encoder 220, hard disk drive 230, MPEG2 encoder/decoder 240, and controller 250. Video recorder 150 further comprises video unit 260, text summary generator 270, and memory 280. Controller 250 directs the overall operation of video recorder 150, including View mode, Record mode, Play mode, Fast Forward (FF) mode, Reverse mode, and other similar functions. Controller 250 also directs the creation, display and interaction of multimedia summaries in accordance with the principles of the present invention.

In View mode, controller 250 causes the incoming television signal from the cable service provider to be demodulated and processed by video processor 210 and transmitted to television set 105, with or without storing video signals on (or retrieving video signals from) hard disk drive 230. Video processor 210 contains radio frequency (RF) front-end circuitry for receiving incoming television signals from the cable service provider, tuning to a user-selected channel, and converting the selected RF signal to a baseband television signal (e.g., super video signal) suitable for display on television set 105. Video processor 210 also is capable of receiving a conventional signal from MPEG2 encoder/decoder 240 and video frames from memory 280 and transmitting a baseband television signal (e.g., super video signal) to television set 105.

In Record mode, controller 250 causes the incoming television signal to be stored on hard disk drive 230. Under the control of controller 250, MPEG2 encoder 220 receives an incoming analog television signal from the cable service provider and converts the received RF signal to MPEG format for storage on hard disk drive 230. Note that in the case of a digital television signal, the signal may be stored directly on hard disk drive 230 without being encoded in MPEG2 encoder 220.

In Play mode, controller 250 directs hard disk drive 230 to stream the stored television signal (i.e., a program) to MPEG2 encoder/decoder 240, which converts the MPEG2 data from hard disk drive 230 to, for example, a super video (S-Video) signal that video processor 210 transmits to television set 105.

It should be noted that the choice of the MPEG2 standard for MPEG2 encoder 220 and MPEG2 encoder/decoder 240 is by way of illustration only. In alternate embodiments of the present invention, the MPEG encoder and decoder may comply with one or more of the MPEG-1, MPEG-2, and MPEG-4 standards, or with one or more other types of standards.

For the purposes of this application and the claims that follow, hard disk drive 230 is defined to include any mass storage device that is both readable and writable, including, but not limited to, conventional magnetic disk drives and optical disk drives for read/write digital versatile disks (DVD-RW), re-writable CD-ROMs, VCR tapes and the like. In fact, hard disk drive 230 need not be fixed in the conventional sense that it is permanently embedded in video recorder 150. Rather, hard disk drive 230 includes any mass storage device that is dedicated to video recorder 150 for the purpose of storing recorded video programs. Thus, hard disk drive 230 may include an attached peripheral drive or removable disk drives (whether embedded or attached), such as a juke box device (not shown) that holds several read/write DVDs or re-writable CD-ROMs. As illustrated schematically in FIG. 2, removable disk drives of this type are capable of receiving and reading re-writable CD-ROM disk 235.

Furthermore, in an advantageous embodiment of the present invention, hard disk drive 230 may include external mass storage devices that video recorder 150 may access and control via a network connection (e.g., Internet protocol (IP) connection), including, for example, a disk drive in the viewer's home personal computer (PC) or a disk drive on a server at the viewer's Internet service provider (ISP).

Controller 250 obtains information from video processor 210 concerning video signals that are received by video processor 210. When controller 250 determines that video recorder 150 is receiving a video program, controller 250 determines if the video program is one that has been selected to be recorded. If the video program is to be recorded, then controller 250 causes the video program to be recorded on hard disk drive 230 in the manner previously described. If the video program is not to be recorded, then controller 250 causes the video program to be processed by video processor 210 and transmitted to television set 105 in the manner previously described.

Memory 280 may comprise random access memory (RAM) or a combination of random access memory (RAM) and read only memory (ROM). Memory 280 may comprise a non-volatile random access memory (RAM), such as flash memory. In an alternate advantageous embodiment of television receiver 105, memory 280 may comprise a mass storage data device, such as a hard disk drive (not shown). Memory 280 may also include an attached peripheral drive or removable disk drives (whether embedded or attached) that reads read/write DVDs or re-writable CD-ROMs. As illustrated schematically in FIG. 2, removable disk drives of this type are capable of receiving and reading re-writable CD-ROM disk 285.

As the video program is being recorded on hard disk drive 230 (or, alternatively, after the video program has been recorded on hard disk drive 230), controller 250 obtains a text summary of the recorded video program using text summary generator 270. Text summary generator 270 uses the method and apparatus for summarizing a video program that is set forth and described in U.S. patent application Ser. No. [Docket No. PHA 701137] filed [Filing Date], entitled “METHOD AND APPARATUS FOR THE SUMMARIZATION AND INDEXING OF VIDEO PROGRAMS USING TRANSCRIPT INFORMATION.” Text summary generator 270 receives the video program as a video/audio/data signal. From the video/audio/data signal text summary generator 270 generates a program summary, a table of contents, and a program index of the video program. Text summary generator 270 uses a time stamp associated with each line of text to identify a selected key frame of video corresponding to the text.

A multimedia summary is a video/audio/text summary. Controller 250 creates a multimedia summary that displays information that summarizes the content of the video program. Controller 250 uses the program summary generated by text summary generator 270 to create the multimedia summary of the video program by adding appropriate video images. The multimedia summary is capable of displaying: 1) text, and 2) still video images comprising a single video frame, and 3) moving video images (referred to as a video “clip” or a video “segment”) comprising a series of video frames, and 4) audio, and 5) any combination thereof.

Controller 250 obtains video images from the video program to be summarized by using video unit 260. Video unit 260 uses the method and apparatus for linking video segments that is set forth and described in U.S. patent application Ser. No. 09/351,086 filed Jul. 9, 1999, entitled “METHOD AND APPARATUS FOR LINKING A VIDEO SEGMENT TO ANOTHER SEGMENT OR INFORMATION SOURCE.”

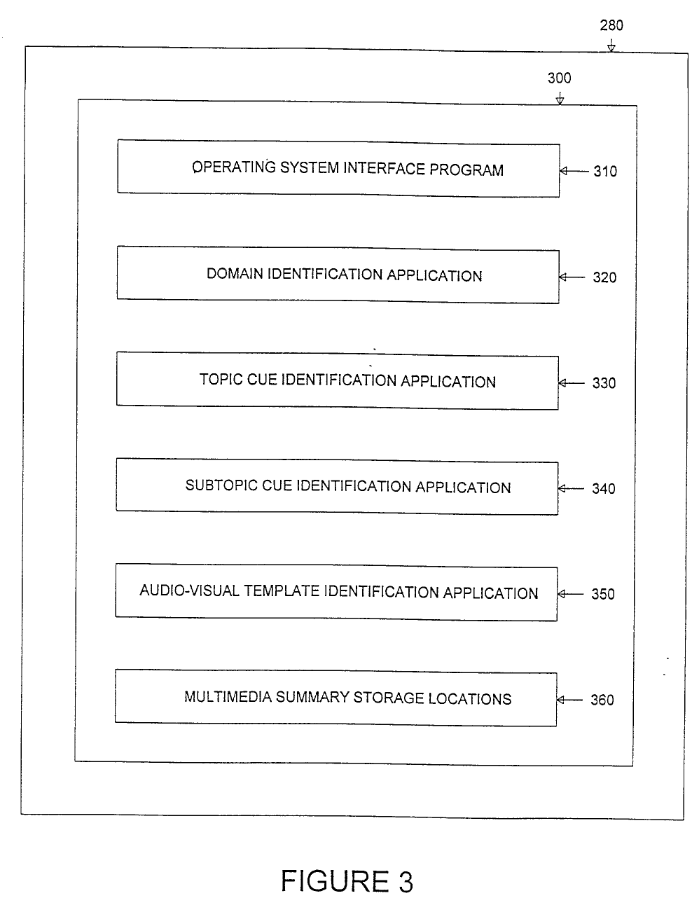

Controller 250 must identify the appropriate video images to be used to create the multimedia summary. An advantageous embodiment of the present invention comprises computer software 300 capable of identifying the appropriate video images to be used to create the multimedia summary. FIG. 3 illustrates a selected portion of memory 280 that contains computer software 300 of the present invention. Memory 280 contains operating system interface program 310, domain identification application 320, topic cue identification application 330, subtopic cue identification application 340, audio-visual template identification application 350, and multimedia summary storage locations 360.

Controller 250 and computer software 300 together comprise a multimedia summary generator that is capable of carrying out the present invention. Under the direction of instructions in computer software 300 stored within memory 280, controller 250 creates multimedia summaries of video programs, stores the multimedia summaries in multimedia summary storage locations 360, and replays the stored multimedia summaries at the request of the viewer. Operating system interface program 310 coordinates the operation of computer software 300 with the operating system of controller 250.

To create a multimedia summary, controller 250 first accesses text summary generator 270 to obtain the text summary of a recorded video program. Controller 250 then identifies appropriate video images to be selected for inclusion in the text summary to create the multimedia summary. In order to do this, controller 250 first identifies the type of the video program (referred to as a “domain” or “category” or “genre”). For example, the “domain” (or “category” or “genre”) of a video program may be a “talk show” or a “news program.” In the description that follows the term “domain” will be used.

Domain identification application 320 in software 300 comprises a database of types of domains (the “domain database”) The domain database contains identifying characteristics of each type of domain that is stored in the domain database. Controller 250 accesses domain identification application 320 to identify the type of video program that is being summarized. Domain identification application 320 compares the identifying characteristics of each type of domain with the characteristics of the video program being summarized. Using the results of the comparison, domain identification application 320 identifies the domain of the video program.

Controller 250 then identifies a word or phrase (referred to as a “topic cue”) that is associated with a topic of the video program. For example, a topic cue for a “talk show” video program may be the words “first guest” or the words “next guest.” Similarly, a topic cue for a “news program” video program may be the words “live from” or the words “we now go to.” The particular words or phrases that are selected as topic cues are chosen to indicate transition points (i.e., changes in topics) in the video program. This allows the video program to be divided into portions that deal with different topics.

Topic cue identification application 330 in software 300 comprises a database of topic cues (the “topic cue database”). The topic cue database contains topic cues for each type of domain that is stored in the domain database. Controller 250 accesses topic due identification application 330 to identify a topic cue in the video program that is being summarized. Topic cue identification application 320 compares each topic cue in the topic cue database with the text summary of the video program being summarized.

When a topic cue is found, controller 250 accesses audiovisual template identification application 350 to identify an audio-video segment (referred to as an “audio-visual template”) that is associated with the topic cue. An appropriate audio-visual template for a “first guest” topic cue in a talk show video program is an audio-video segment showing the guest. The identity of the “first guest” may be obtained from the name of the guest mentioned in the text. For example, when the host of a talk show says, “Our first guest is the one, the only, Dolly Parton,” then topic cue identification application 330 identifies the words “first guest” as a topic cue. The identity of the first guest Dolly Parton is obtained from the text summary.

Audio-visual template identification application 350 must then identify and obtain an audio-video segment of Dolly Parton as the audio-visual template to be selected for addition to the multimedia summary. Within a few seconds after her introduction, Dolly Parton walks onto the stage. Her face will then be visible and will occupy a portion of the video image. As described more fully below, audio-visual template identification application 350 identifies an image of Dolly Parton's face, extracts an audio-video template with the image of Dolly Parton's face and adds it to the multimedia summary.

Audio-visual template identification application 350 identifies an image of Dolly Parton's face in the following manner. From video images that are shown immediately after the introduction of Dolly Parton, audio-visual template identification application 350 selects an image of the face of a person that is not an image of the face of the talk show host (or any of the talk show “regulars” such as musicians, etc.). Audio-visual template identification application 350 then assumes that the image of that person is the image of Dolly Parton.

This assumption will be incorrect if audio-visual template identification application 350 acquired the image of a member of the audience whose image appeared in the video right after Dolly Parton was introduced. It is therefore necessary to confirm the assumption by checking the identification fo the person in the initially selected image after a few minutes have passed. This may be done by checking an identifying characteristic such as an image of the face, a voice, a name plate of the guest, or some other similar identifying characteristic.

Because Dolly Parton will appear during the next ten or twelve minutes of the talk show, there will be time to analyze the image of the guest to make sure that the initial image selected is actually an image of Dolly Parton. If a later check shows that the assumption was wrong and that the initial image selected was not that of Dolly Parton, then a correction may be made by replacing the image with an image of Dolly Parton.

In an alternate advantageous embodiment of the present invention, a database (not shown) of images of faces of celebrities may be used in conjunction with audio-visual template identification application 350. The image of a face of a person from a video (e.g., talk show guest) may be compared with each of the images of the faces of the celebrities in the database. Face matching can be accomplished by using Principal Component Analysis (PCA) techniques or other similar equivalent techniques. If a match is found, the person is identified. If no match is found, then the image of the face of the person is not in the celebrity database. In that case, the procedure described above that was used to identify Dolly Parton must be used to identify the person.

After a celebrity who is not in the celebrity database is identified, the celebrity is added to the database. The content of the celebrity database may be continually changed by adding persons to the database or deleting persons from the database. In this manner the list of celebrities in the celebrity database is always kept current.

Other methods for detecting and identifying faces in video segments are described in a paper entitled “Region-Based Segmentation and Tracking of Human Faces” by V. Vilaplana, F. Marques, P. Salembier and L. Garrido, Paper presented at the Ninth European Signal Processing Conference EUSIPCO-98, Rhodes (1998) and in a paper entitled “Name-It: Naming and Detecting Faces in News Videos” by S. Satoh, Y. Nakamura & T. Kanade, IEEE Multimedia, Volume 6(1), pp. 22-35 (1999).

In another application, an audio-video template for a sports program could comprise 1) a prespecified overall motion for a certain time period or 2) a sequence of types of motion. For example, a topic cue in a “soccer game” video program may be the words “goal” or “first goal.” After the topic cue has been identified, audio-visual template identification application 350 must then identify and obtain an audio-video clip of the first goal being scored as the audio-visual template to be selected for addition to the multimedia summary.

To identify when the goal was scored, audio-visual template identification application 350 first detects the goal in fast motion and then detects the goal in slow motion. When the temporal position of the goal is located, an audio-video clip may be extracted that covers a period of time during which the goal was scored. For example, the audio-video clip may extend from a point in time five (5) seconds before the goal was scored to a point in time five (5) seconds after the goal was scored. In this manner, a multimedia summary of a sports program may consist of a series of replays of program segments in which goals were scored.

In another example, a topic cue in a “news show” video program may be the words “live from.” An appropriate audio-visual template for a “live from” topic cue in a news show video program may be an audio-video segment of the location where the “live from” reporting is being conducted. Alternatively, the audio-visual template may be an audio-video segment of the reporter who is conducting the “live from” reporting.

When the news anchor of a news program says, “Now live from Las Vegas,” then topic cue identification application 330 identifies the words “live from” as a topic cue and audio-visual template identification application 350 identifies an audio-video segment of Las Vegas as the audio-visual template to be selected for addition to the multimedia summary.

Audio-visual template identification application 350 associates a set of audio-visual templates with each set of topic cues contained within the topic cue database for a particular type of domain. Controller 250 and audio-visual template identification application 350 access video unit 260 to obtain the appropriate audio-visual template to be included in the multimedia summary for the topic.

Audio-visual templates comprise both video signals and audio signals. It is possible, however, that in some applications an audio-visual template may contain only one type of signal (i.e., either an audio signal or a video signal but not both). The principles of operation for an audio-visual template having only one type of signal are the same as the principles of operation for an audio-visual template having both video signals and audio signals.

After controller 250 and audio-visual template identification application 350 identify and obtain the appropriate audio-visual template, controller 250 then adds the topic cue and corresponding audio-visual template to the multimedia summary. The location of the topic cue in the multimedia summary is defined to be an “entry point” in the multimedia summary. An entry point is a location in the multimedia summary that can be directly accessed by a viewer who subsequently views the multimedia summary. The viewer is presented with a user interface that offers access to a list of all the entry points in the multimedia summary. If the viewer is interested in a particular topic in the multimedia summary, the viewer can cause the topic in the multimedia summary to be displayed by accessing the entry point of the topic.

After controller 250 has identified a topic, controller 250 then identifies a word or phrase (referred to as a “subtopic cue”) that is associated with a subtopic of the topic. For example, a subtopic cue for a topic cue of “first guest” in a talk show video program may be the words “new movie” or the words “new book.” The subtopics may refer to work projects or interesting episodes in the life of the “first guest.” The particular words or phrases that are selected as subtopic cues are chosen to indicate transition points (i.e., changes in subtopics) in the topic. This allows the topic to be divided into portions that deal with different subtopics.

Subtopic cue identification application 340 in software 300 comprises a database of subtopic cues (the “subtopic cue database”). The subtopic cue database contains subtopic cues for each type of topic cue that is stored in the topic cue database. Controller 250 accesses subtopic due identification application 340 to identify a subtopic cue in the topic that is being summarized. Subtopic cue identification application 340 compares each subtopic cue in the subtopic cue database with the text summary of the topic that is being summarized.

When a subtopic cue is found, controller 250 then accesses audio-visual template identification application 350 to identify an audio-visual template that is associated with the subtopic cue. For example, an audio-visual template for a “new movie” subtopic cue in a talk show video program may be a still video image showing the name of the new movie. Alternatively, the audio-visual template for a “new movie” subtopic cue in a talk show video program may be an audio-video segment (or “clip”) from the new movie.

When the host of a talk show says, “Now we have a clip from Tom Hank's new movie,” then subtopic cue identification application 340 identifies the words “new movie” as a subtopic cue and audio-visual template identification application 350 identifies an audio-video segment of the new movie as the audio-visual template to be selected for addition to the multimedia summary.

Audio-visual template identification application 350 associates a set of audio-visual templates with each set of subtopic cues contained within the subtopic cue database for a particular type of topic. Controller 250 and audio-visual template identification application 350 access video unit 260 to obtain the appropriate audio-visual segments to be included in the multimedia summary for the subtopic.

After controller 250 and audio-visual template identification application 350 identify and obtain the appropriate audio-visual template, controller 250 then adds the subtopic cue and corresponding audio-visual template to the multimedia summary. As in the case of a topic cue, the location of the subtopic cue in the multimedia summary is defined to be an “entry point” in the multimedia summary. If the viewer is interested in a particular subtopic in the multimedia summary, the viewer can cause the subtopic in the multimedia summary to be displayed by accessing the entry point of the subtopic.

Controller 250 continues the above described process for identifying topic cues and subtopic cues associated with the domain of the video program. As the process continues, controller 250 creates the multimedia summary of the video program. Controller 250 stores the multimedia summary in multimedia summary storage locations 360 in memory 280. Controller 250 may also transfer one or more multimedia summaries to hard disk drive 230 for long term storage.

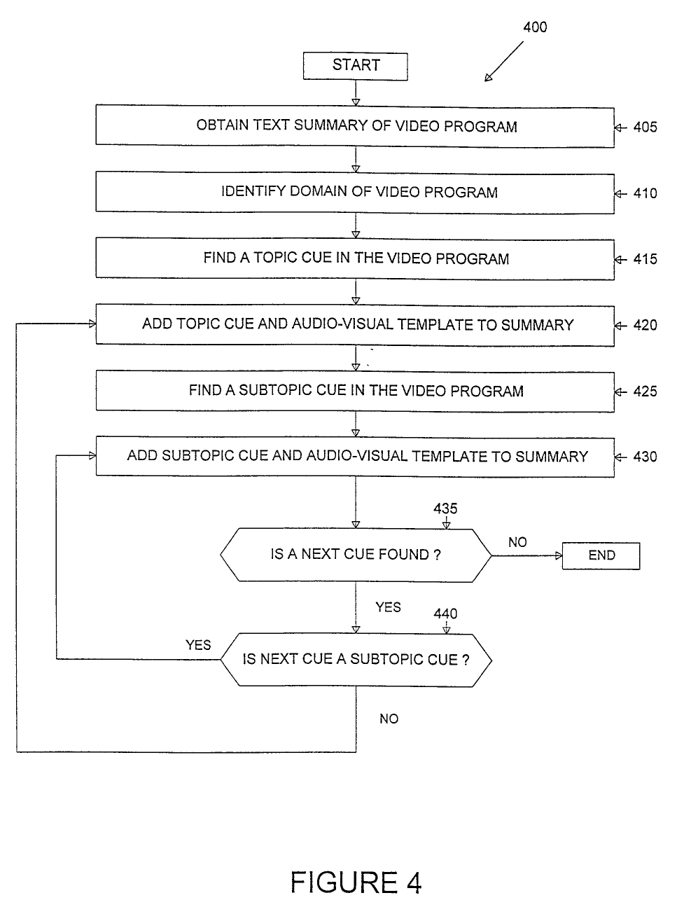

The process of creating the multimedia summary may be more clearly understood with reference to FIG. 4. FIG. 4 depicts flow diagram 400 illustrating the operation of the method of an advantageous embodiment of the present invention. The process steps set forth in flow diagram 400 are executed in controller 250. Controller 250 causes text summary generator 270 to summarize the text of a video program in the manner previously described (process step 405). Controller 250 then identifies the domain of the video program (process step 410). Controller 250 then compares the text of the video program with a database of topic cues to find a topic cue associated with the identified domain of the video program (process step 415).

When a topic cue is found, controller 250 obtains an associated audio-visual template for the topic cue and links the audio-visual template to the topic cue. Controller 250 then saves the topic cue and its associated audio-visual template in the multimedia summary (process step 420).

Controller 250 then compares the text of the video program with a database of subtopic cues to find a subtopic cue associated with the identified topic cue of the video program (process step 425). When a subtopic cue is found, controller 250 obtains an associated audio-visual template for the subtopic cue and links the audio-visual template to the subtopic cue. Controller 250 then saves the subtopic cue and its associated audio-visual template in the multimedia summary (process step 430).

Controller 250 continues to search for the next subtopic cue or the next topic cue (decision step 435). If controller 250 determines that there are no more subtopic cues or topic cues, or if the end of the video program has been reached, then the summarizing process ends.

If controller 250 finds a next cue, then controller 250 determines whether the next cue is a subtopic cue (decision step 440). If the next cue is a subtopic cue, control goes to process step 430 and the subtopic cue and its associated audio-visual template are added to the multimedia summary. If the next cue is not a subtopic cue, then it is a topic cue. Control then goes to process step 420 the topic cue and its associated audio-visual template are added to the multimedia summary. In this manner the multimedia summary is assembled by topic and by subtopic.

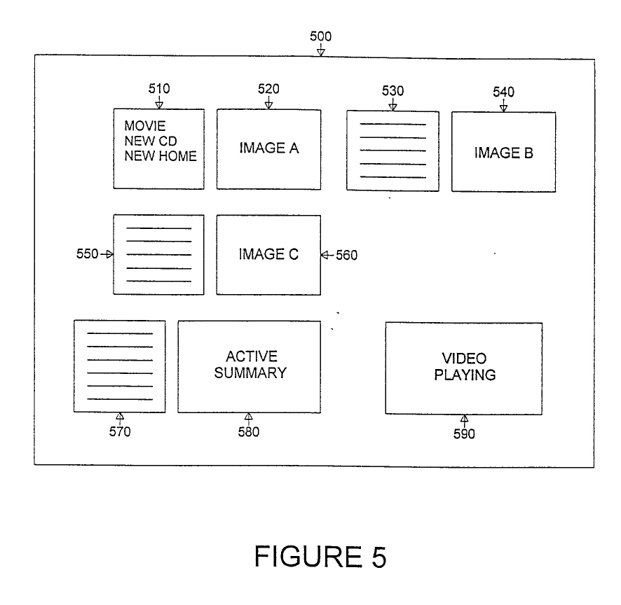

FIG. 5 illustrates an exemplary display page of an advantageous embodiment of the viewer interactive multimedia summary of the present invention. FIG. 5 illustrates how the entry points for the entire multimedia summary may be displayed on a single page. For example, assume that the page shown in FIG. 5 depicts the multimedia summary of a talk show video program. Image A 520 shows the face of the first guest, image B 540 shows the face of the second guest, and image C 560 shows the face of the third guest. Text section 510 contains a list of the subtopics discussed by first guest 520. In the example shown in FIG. 5, these subtopics are Movie, New CD, and New Home. Similarly, text section 530 contains a list of the subtopics discussed by second guest 540 and text section 550 contains a list of subtopics discussed by third guest 560.

The viewer can select any subtopic in any of the three text lists 510, 530 or 550 for display by the multimedia summary. The viewer can indicate the desired subtopic to be displayed by using remote control 125 to send a signal to select one of the subtopics as each subtopic is sequentially highlighted as a menu item. Alternatively, the viewer can indicate the desired subtopic with a pointing device such as a computer mouse (not shown) in video display systems that are so equipped.

When the viewer selects a particular subtopic, the summary for that subtopic is displayed in the portion of the screen identified as active summary 580. An audio-video clip that is related to the subtopic is simultaneously played on the portion of the screen identified as video playing 590. For example, if the subtopic is “Movie,” then the audio-video clip could be a clip from the movie. If the subtopic is “Soccer Game,” then the audio-video clip could be a clip of the goals that were scored in the game. Active summary 580 is generated to display a summary of topics and subtopics related to topics selected by the viewer. If the viewer selects a new topic or a new subtopic, the summary displayed in active summary 580 reflects a summary of topics and subtopics related to the newly chosen topic or subtopic.

Text section 570 contains a list of all of the topics of the video program. For example, for a talk show video program text section 570 contains a list of all of the topics of the talk show video program. In this example, three of the items in the list in text section 570 are the names of the three guests. Other items listed in text section 570 relate to other topics in the talk show video program (e.g., host monologue at the beginning of the show). The viewer can select for display any of the topics listed in text section 570. When a topic is selected, an audio-video clip that is related to the topic is played on the portion of the screen identified as “video playing” (portion 590).

This mode of display of the multimedia summary involves interaction by the viewer to select individual portions of the multimedia summary for display. Another mode of display of the multimedia summary is the “play through” mode. In the “play through” mode, the multimedia summary begins at the beginning of the video program and plays straight through without any interaction by the viewer. The viewer can intervene at any time to stop the “play through” mode by selecting a topic or a subtopic for display.

The multimedia summary of the present invention can also be used in conjunction with methods and apparatus for ordering products and services that are discussed during a video program. For example, a viewer may desire to purchase a book that has been discussed during a talk show video program. Products and services may be ordered directly using the method and apparatus set forth and described in U.S. patent application Ser. No. [Docket No. PHA 701071] filed [Filing Date], entitled “SYSTEM AND METHOD FOR ORDERING ONLINE UTILIZING A DIGITAL TELEVISION RECEIVER.”

The multimedia summary of the present invention can also be used in conjunction with methods and apparatus for obtaining additional information concerning the viewer's interests. For example, if the viewer selects a subtopic that describes a new movie that will soon be released, this viewer inquiry can be recorded for future reference. The multimedia summary can later notify the viewer when the movie is released and provide show times and ticket prices from nearby theaters. The notification may be attached to a summary of a related program. Alternatively, the notification could be sent to the viewer through electronic mail or a similar communications link. The notification could also generate an audible alarm (e.g., a “beep” tone) on a personal computer, a personal digital assistant, or other similar type of communications equipment.

An event matching engine may be used to locate events that occur within a local geographical area. For example, during a talk show program the actor Kevin Spacey says that he is currently appearing in a movie called “American Beauty.” If the viewer selects the subtopic “American Beauty,” then the multimedia summary can use the indication of the viewer's interest to search for information about the movie “American Beauty” on other programs (e.g., news programs) or on local web sites over a period of time (e.g., several months).

When additional information is located concerning the show times and prices of the movie “American Beauty,” the multimedia summary can overlay the telephone number 1-800-FILM-777, and/or can notify the viewer that the movie is scheduled to appear on Pay Per View television, and/or can automatically e-mail or display information concerning the show times and prices of the movie in local theaters. Tickets to the show may be directly ordered using the method described above.

The multimedia summary of the present invention enables a viewer to use the topics and subtopics from the multimedia summary to find additional information of interest over an extended period of time. The multimedia summary keeps actively working and searching for information of interest to the viewer. Any new additional information that is located based upon a multimedia summary of a first program may also be attached to a multimedia summary of a second program if the second program has topics, subtopics or keywords that are similar to the first program.

Although the present invention has been described in detail, those skilled in the art should understand that they can make various changes, substitutions and alterations herein without departing from the spirit and scope of the invention in its broadest form.

What is claimed is:

1. For use in a video display system capable of displaying a video program, a system for creating a multimedia summary of said video program, said system comprising:
a multimedia summary generator capable of obtaining a transcript of the text of said video program and capable of obtaining audio-video segments of said video program,
wherein said multimedia summary generator is capable of combining portions of said transcript and portions of said audio-video segments to create a multimedia summary of said video program.

2. The system as claimed in claim 1 wherein said multimedia summary generator is capable of creating said multimedia summary by selecting an audio-video segment that relates to a topic of said video program, and by adding said topic and said audio-video segment to said multimedia summary.

3. The system as claimed in claim 2 wherein said multimedia summary generator comprises:
a controller capable of executing computer software instructions contained within a memory coupled to said controller to create said multimedia summary of said video program by identifying at least one topic cue in said transcript of said video program, and by selecting at least one audio-visual template associated with said at least one topic cue, and by adding said topic cue and said audio-visual template to said multimedia summary.

4. The system as claimed in claim 3 wherein said controller is capable of executing computer software instructions contained within a memory coupled to said controller to create said multimedia summary of said video program by identifying at least one subtopic cue for said at least one topic of said video program, and by selecting at least one audio-visual template associated with said at least one subtopic cue, and by adding said subtopic cue and said audio-visual template to said multimedia summary.

5. The system as claimed in claim 3 wherein said controller is capable of executing:
a domain identification application capable of identifying a type of said video program;
a topic cue identification application capable of identifying at least one topic cue in said transcript of said video program;
a subtopic cue identification application capable of identifying at least one subtopic cue in said at least one topic of said video program; and
an audio-visual template identification application capable of identifying at least one audio-visual template associated with said at least one topic cue, and capable of identifying at least one audio-visual template associated with said at least one subtopic cue.

6. The system as claimed in claim 4 wherein said controller is capable of executing computer software instructions contained within a memory coupled to said controller to create an entry point for each topic that will allow a viewer to access each topic in said multimedia summary, and to create an entry point for each subtopic that will allow a viewer to access each subtopic in said multimedia summary.

7. A video display system capable of creating a multimedia summary of a video program, said video display system comprising:
a multimedia summary generator capable of obtaining a transcript of the text of said video program and capable of obtaining audio-video segments of said video program,
wherein said multimedia summary generator is capable of combining portions of said transcript and portions of said audio-video segments to create a multimedia summary of said video program.

8. The video display system as claimed in claim 7 wherein said multimedia summary generator is capable of creating said multimedia summary by selecting an audio-video segment that relates to a topic of said video program, and by adding said topic and said audio-video segment to said multimedia summary.

9. The video display system as claimed in claim 8 wherein said multimedia summary generator comprises:
a controller capable of executing computer software instructions contained within a memory coupled to said controller to create said multimedia summary of said video program by identifying at least one topic cue in said transcript of said video program, and by selecting at least one audio-visual template associated with said at least one topic cue, and by adding said topic cue and said audio-visual template to said multimedia summary.

10. The video display system as claimed in claim 9 wherein said controller is capable of executing computer software instructions contained within a memory coupled to said controller to create said multimedia summary of said video program by identifying at least one subtopic cue for said at least one topic of said video program, and by selecting at least one audio-visual template associated with said at least one subtopic cue, and by adding said subtopic cue and said audio-visual template to said multimedia summary.

11. The video display system as claimed in claim 9 wherein said controller is capable of executing:
a domain identification application capable of identifying a type of said video program;
a topic cue identification application capable of identifying at least one topic cue in said transcript of said video program;
a subtopic cue identification application capable of identifying at least one subtopic cue in said at least one topic of said video program; and
an audio-visual template identification application capable of identifying at least one audio-visual template associated with said at least one topic cue, and capable of identifying at least one audio-visual template associated with said at least one subtopic cue.

12. The video display system as claimed in claim 10 wherein said controller is capable of executing computer software instructions contained within a memory coupled to said controller to create an entry point for each topic that will allow a viewer to access each topic in said multimedia summary, and to create an entry point for each subtopic that will allow a viewer to access each subtopic in said multimedia summary.

13. For use in a video display system capable of displaying a video program, a method for creating a multimedia summary of said video program, said method comprising the steps of:
obtaining a transcript of the text of said video program in a multimedia summary generator;
obtaining audio-video segments of said video program in said multimedia summary generator; and
combining portions of said transcript and portions of said audio-video segments in said multimedia summary generator to create said multimedia summary of said video program.

14. The method as claimed in claim 13 wherein the step of combining portions of said transcript and portions of said audio-video segments in said multimedia summary generator to create said multimedia summary of said video program comprises:
selecting an audio-video segment that relates to a topic of said video program; and
adding said topic and said audio-video segment to said multimedia summary.

15. The method as claimed in claim 14 further comprising the steps of:
receiving in a multimedia summary generator instructions from computer software stored in a memory coupled to said multimedia summary generator;
executing said instructions in said multimedia summary generator to identify at least one topic cue in said transcript of said video program;
executing said instructions in said multimedia summary generator to select at least one audio-visual template associated with said at least one topic cue; and
executing said instructions in said multimedia summary generator to add said topic cue and said audio-visual template to said multimedia summary.

16. The method as claimed in claim 15 further comprising the steps of:
receiving in a multimedia summary generator instructions from computer software stored in a memory coupled to said multimedia summary generator;
executing said instructions in said multimedia summary generator to identify at least one subtopic cue for said at least one topic of said video program;
executing said instructions in said multimedia summary generator to select at least one audio-visual template associated with said at least one subtopic cue; and
executing said instructions in said multimedia summary generator to add said subtopic cue and said audio-visual template to said multimedia summary.

17. The method as claimed in claim 15 further comprising the steps of:
identifying a type of said video program with a domain identification application;
identifying at least one topic cue in said transcript of said video program with a topic cue identification application;
identifying at least one subtopic cue in said at least one topic of said video program with a subtopic cue identification application;
identifying at least one audio-visual template associated with said at least one topic cue with an audio-visual template identification application; and
identifying at least one audio-visual template associated with said at least one subtopic cue with said audio-visual template identification application.

18. The method as claimed in claim 16 further comprising the steps of:
receiving in a multimedia summary generator instructions from computer software stored in a memory coupled to said multimedia summary generator;
executing said instructions in said multimedia summary generator to create an entry point for each topic that will allow a viewer to access each topic in said multimedia summary; and
executing said instructions in said multimedia summary generator to create an entry point for each subtopic that will allow a viewer to access each subtopic in said multimedia summary.

19. For use in a video display system capable of displaying a video program, computer-executable instructions stored on a computer-readable storage medium for creating a multimedia summary of said video program, the computer-executable instructions comprising the steps of:
obtaining a transcript of the text of said video program in a multimedia summary generator;
obtaining audio-video segments of said video program in said multimedia summary generator; and
combining portions of said transcript and portions of said audio-video segments in said multimedia summary generator to create said multimedia summary of said video program.

20. The computer-executable instructions stored on a computer-readable storage medium as claimed in claim 19 wherein the step of combining portions of said transcript and portions of said audio-video segments in said multimedia summary generator to create said multimedia summary of said video program comprises:
selecting an audio-video segment that relates to a topic of said video program; and
adding said topic and said audio-video segment to said multimedia summary.

21. The computer-executable instructions stored on a computer-readable storage medium as claimed in claim 20 further comprising the steps of:
receiving in a multimedia summary generator instructions from computer software stored in a memory coupled to said multimedia summary generator;
executing said instructions in said multimedia summary generator to identify at least one topic cue in said transcript of said video program;
executing said instructions in said multimedia summary generator to select at least one audio-visual template associated with said at least one topic cue; and
executing said instructions in said multimedia summary generator to add said topic cue and said audio-visual template to said multimedia summary.

22. The computer-executable instructions stored on a computer-readable storage medium as claimed in claim 21 further comprising the steps of:
receiving in a multimedia summary generator instructions from computer software stored in a memory coupled to said multimedia summary generator;
executing said instructions in said multimedia summary generator to identify at least one subtopic cue for said at least one topic of said video program;
executing said instructions in said multimedia summary generator to select at least one audio-visual template associated with said at least one subtopic cue; and
executing said instructions in said multimedia summary generator to add said subtopic cue and said audio-visual template to said multimedia summary.

23. The computer-executable instructions stored on a computer-readable storage medium as claimed in claim 21 further comprising the steps of:
identifying a type of said video program with a domain identification application;
identifying at least one topic cue in said transcript of said video program with a topic cue identification application;
identifying at least one subtopic cue in said at least one topic of said video program with a subtopic cue identification application;
identifying at least one audio-visual template associated with said at least one topic cue with an audio-visual template identification application; and
identifying at least one audio-visual template associated with said at least one subtopic cue with said audio-visual template identification application.

24. The computer-executable instructions stored on a computer-readable storage medium as claimed in claim 22 further comprising the steps of:
receiving in a multimedia summary generator instructions from computer software stored in a memory coupled to said multimedia summary generator;
executing said instructions in said multimedia summary generator to create an entry point for each topic that will allow a 9 viewer to access each topic in said multimedia summary; and
executing said instructions in said multimedia summary generator to create an entry point for each subtopic that will allow a viewer to access each subtopic in said multimedia summary.

25. For use in a video display system capable of displaying a video program, a multimedia summary of a video program comprising at least one audio-visual segment of said video program.

26. The multimedia summary of a video program as claimed in claim 25 further comprising at least one portion of a transcript of said video program.

27. The multimedia summary of a video program as claimed in claim 25 comprising at least one audio-visual segment of said video program that relates to at least one topic of said video program.

28. The multimedia summary of a video program as claimed in claim 27 comprising at least one audio-visual segment of said video program that relates to at least one subtopic in said at least one topic of said video program.

29. The multimedia summary of a video program as claimed in claim 25 wherein said multimedia summary is capable of displaying one of:
text from said video program, audio from said video program, a single video frame from said video program, a video segment comprising a series of video frames from said video program, and an audio-visual segment comprising audio from said video program and a series of video frames from said video program.

30. The multimedia summary of a video program as claimed in claim 27 comprising a plurality of audio-visual segments of said video program, wherein each of said plurality of audio-visual segments relates to a topic of said video program.

31. The multimedia summary of a video program as claimed in claim 30 further comprising a topic entry point associated with each of said plurality of audio-visual segments that relates to a topic, in which each topic entry point allows a viewer to access the audio-visual segment associated with said topic.

32. The multimedia summary of a video program as claimed in claim 30 comprising a plurality of audio-visual segments of said video program, wherein each of said plurality of audio-visual segments relates to a subtopic of a topic of said video program.

33. The multimedia summary of a video program as claimed in claim 32 further comprising a subtopic entry point associated with each of said plurality of audio-visual segments that relates to a subtopic, in which each subtopic entry point allows a viewer to access the audio-visual segment associated with said subtopic.

34. For use in a video display system capable of displaying a video program, a multimedia summary of a video program comprising
a plurality of audio-visual segments of said video program that relate to at least one topic of said video program; and
at least one topic entry point associated with said plurality of audio-visual segments that relate to said at least one topic of said video program, in which said at least one topic entry point allows a viewer to access the plurality of audio-visual segments associated with said topic.

35. The multimedia summary of a video program as claimed in claim 34 further comprising
a plurality of audio-visual segments of said video program that relate to at least one subtopic of said at least one topic of said video program; and
at least one subtopic entry point associated with said plurality of audio-visual segments that relate to said at least one subtopic of said at least one topic of said video program, in which said at least one subtopic entry point allows a viewer to access the plurality of audio-visual segments associated with said subtopic.

36. The method as claimed in claim 13, said method further comprising the steps of:
obtaining an image of a face of a person in said video program with audio-visual template identification application after said person first appears in said video program;
subsequently confirming the identity of said person by checking at least one identifying characteristic of said person; and
adding said image of said person to said multimedia summary after the identity of said person has been confirmed.

37. The method as claimed in claim 36 wherein said at least one identifying characteristic of said person comprises one of:
an identification of the face of said person, an identification of the voice of said person, and a name plate of said person.

38. The method as claimed in claim 36 wherein at least one identifying characteristic of said person comprises an identification of the face of said person and an identification of the voice of said person.
